(19) United States
(12) Patent Application Publication
(10) Pub. No.: US 2017/0111522 A1
(43) Pub. Date: Apr. 20, 2017

(54) A METHOD FOR CONTROLLING TRANSFER OF PRINT DATA, A CLIENT CONTROLLER ARRANGEMENT, A PRINT ARRANGEMENT AND A NETWORK

(71) Applicant: LEVI, RAY & SHOUP, INC., Springfield, IL (US)

(72) Inventors: Robert Pike, North Somerset (GB); Roger Åström, Saltsjö-Duvnäs (SE); Gorm Hallberg-Lange, Stockholm (SE)

(21) Appl. No.: 15/126,999

(22) PCT Filed: Mar. 17, 2015
(86) PCT No.: PCT/SE2015/050302

§ 371 Date: Sep. 16, 2016

(30) Foreign Application Priority Data
Mar. 17, 2014 (SE) 1450294-2

(51) Int. Cl. H04N 1/00; H04N 1/32; H04N 1/41; G06F 3/12

(52) U.S. Cl. CPC H04N 1/0023; G06F 3/1205; G06F 3/126; H04N 1/32133; H04N 1/32507; H04N 1/32523; H04N 1/32069; H04N 1/41; H04N 2201/0094; H04N 2201/0039

(57) ABSTRACT

The present invention relates to a method for controlling transfer of print data from clients connected in a network to shared printing devices connected in the network. The method comprises the steps of:
providing (S1) print data upon reception of a request to send to a printing device connected in the network,
forming (S2) header information for the print data based on information provided by a configurable logic means, wherein said header information comprises information related to at least one designated printing device controller (140) identified based on the request to print to a printing device,
processing (S3) the print data so as to provide processed print data comprising the formed header information,
sending (S4) the processed print data to the at least one designated printing device controller (140),
receiving (S5) the processed print data at the designated printing device controller,
reading (S6) at the destination printing device controller the header information of the received processed print data and
controlling (S7) the processed print data in accordance with the header information. The controlling comprises forming (S8) reconstructed print data from the processed print data at a destination printing device controller based on the header information, and providing (S9) the reconstructed print data to the printing device.

The invention also relates to a client controller arrangement, a printer arrangement and a network.

### TECHNICAL FIELD

The present invention relates to a method for controlling transfer of print data from clients connected in a network to printing devices connected in the network.

The present invention also relates to a client controller arrangement for controlling transfer of print data from clients connected in a network to one or a plurality of printing devices connected in the network.

The present invention further relates to a printer arrangement for a network comprising clients and printing devices.

The present invention further relates to a network comprising a plurality of clients, a plurality of printing devices and means for controlling transfer of print data in the network.

### BACKGROUND ART

A typical administrator controlled printing system for networks is based on the principle of processing and routing print jobs via a print server, which involves a client in a network that sends a print job to a print server, which receives the print job, processes the print job and sends it further to a printing device. The network comprises a number of clients and/or user computers, which together with a number of printing devices are connected in a network. The network also comprises, inter alia, a number of print servers, which monitor, process and control print jobs from the clients, and sends them to the printing devices. The client sends a print job to one of the print servers. The amount of data, which is sent, is typically at least three times bigger than the original file. When the print job reaches the print server it is locally spooled onto the hard disk drive of the print server, which requires storage space and processing power on the server. When the print server has spooled the print job into the correct print queue (i.e. in the queue for the printing device) and when it is time for the current print job to be printed, the print server sends the print job to the printing device. The print job is not sent directly from the client to the printer, but makes a detour via a print server.

US 2012/0147417 describes a method for controlling and monitoring, from a server, transfers of jobs from clients connected in a network to printing devices connected in a network.

### SUMMARY OF THE INVENTION

One object of the present disclosure is to improve printing flexibility and/or control in a network.

This has in accordance with one embodiment been achieved by means of a method for controlling transfer of print data from clients connected in a network to shared printing devices connected in the network, comprising the following steps. Print data is provided upon reception of a request to print to a printing device connected in the network. The request may be a user request or a request from another device or system. The request may or may not comprise the selection of a printing device(s). Thereafter, header information is formed for the print data based on information provided by configurable logic means. The header information comprises information related to at least one designated printing device controller identified based on the request to print to a printing device. The header information may additionally contain information relating to routing and processing of the print data. The print data is then processed so as to provide processed print data comprising the formed header information. The processed print data is then sent to the at least one designated printing device controller. The processed print data is received at the designated printing device controller. The header information of the received processed print data is read at the designated printing device controller. The processed print data is then controlled in accordance with the header information. The controlling comprises forming reconstructed print data from the processed print data received at a destination printing device controller based on the header information and providing the reconstructed print data to the printing device.

Print data is interpreted to cover any data which is used by the printing device within the normal printing process.

The processed print data received at the designated printing device controller may be routed and/or spawned to another destination printing device controller. Alternatively, the designated printing device controller and the destination printing device controller are the same printing device controller.

One advantage with the present invention as defined above is that efficiency is improved. Increased flexibility and/or functionality is achieved.

In one example, the step of forming the header information further comprises adding routing type information to the header information, wherein the routing type information is provided from the configurable logic means comprising settings for a plurality of routing type options. The step of controlling the processed print data is then performed in accordance with the routing type information.

Embodiments of the method may have one or a plurality of the characterizing features as defined in the dependent claims.

In one example, the plurality of routing type options comprises a direct transfer option, in which option the destination printing device controller is the designated printing device controller and in which option printing is performed at that printing device to which the designated printing device controller is associated.

In one example, wherein the direct transfer option is set in the configurable logic means, the step of forming the reconstructed print data is performed at the designated printing device controller, and the step of providing the reconstructed print data to the printing device comprises providing the reconstructed print data to that printing device to which the designated printing device controller is associated.

In one example, the plurality of routing type options comprises indirect transfer via the designated printing device controller.

The indirect transfer is in one example performed via the designated printing device controller to the destination printing device controller.

The indirect transfer is in one example performed from the designated printing device or destination printing device to a printing device for printing.

In one example, wherein the indirect transfer is set in the configurable logic means, the step of forming the reconstructed print data is performed at the designated or destination printing device controller, and the step of providing the reconstructed print data to the printing device comprises transferring the reconstructed print data to the printing device, wherein the printing device is controlled by the designated or destination printing device controller.

The step of processing the print data comprises further in one example adding information related to the printing device to the print data, wherein the transfer to the printing device is performed based on this information.

In one example the step of processing the print data further comprises adding information related to the destination printing device controller to the print data, wherein the transfer is performed based on this information.

The plurality of routing type options comprises in one example spawn.

In one example, wherein the spawn option is set in the configurable logic means, a spawning step comprises transmitting the processed print data to a group of printing device controllers comprising the designated printing device controller, and the step of providing the reconstructed print data to the printing device comprises providing the reconstructed print data to the printing device based on a printing device user selection made after sending from the client.

In one example, the step of processing the print data further comprises adding information identifying the printing device controllers of the group of printing device controllers.

In one example, the print data is transmitted to the controllers of the group of printing device controllers using peer-to-peer technology.

In one example, the print data is transmitted to the controllers of the group of printing device controllers for use in conjunction with pull printing.

In one example, the forming of the header information comprises including information identifying a plurality of printing device controllers and the sending of the processed print data to the designated printing device controller is performed using multicast or broadcast transmission.

In one example, the step of processing the print data further comprises compressing and/or encoding the print data and the step of forming the reconstructed print data comprises performing decompression and/or decoding.

In one example, the method further comprises a step of performing print spooling on the print data.

In one example, the step of performing print spooling is performed before sending from the client to the printing device.

In one example, the step of performing print spooling is performed at the designated or destination printing device controller.

In one example, a step of performing S85 print spooling is performed in conjunction with pull printing.

The present disclosure also relates to software for executing the steps of the method for controlling transfer of print data.

The present disclosure also relates to a client controller arrangement for controlling transfer of print data from a client connected in a network to one of a plurality of printing devices connected in the network. The client controller arrangement comprises a client controller. The client controller has access to configurable logic means. The configurable logic means may comprise a configurable logic unit located in the client controller arrangement. The client controller is arranged to receive print data from the client upon a request to print to a printing device in the network, form header information for the print data based on information in the configurable logic means, wherein the header information comprises information related to at least one designated printing device controller identified based on the printing device, and processing the print data so as to provide processed print data comprising the formed header information and sending the processed print data to the at least one designated printing device controller.

In accordance with one aspect, the configurable logic means are arranged to store settings identifying one designated printing device controller associated to each of a plurality of the printing devices of the network.

In accordance with one aspect, the configurable logic means comprise settings for a plurality of routing type options, wherein the client controller is arranged to process the print data so as to add routing type information to the print data based on the settings of the configurable logic means.

In accordance with one aspect, the configurable logic unit comprises settings for at least two of the following routing type options:
a direct transfer option, wherein printing is performed at that printing device to which the designated printing device controller is associated
an option for indirect transfer via the designated printing device controller, and
spawn.

In accordance with one aspect, the option for indirect transfer comprises the following two combinable options: an option for indirect transfer to a destination printing device controller, and an option for indirect transfer to the printing device.

In accordance with one aspect, the configurable logic means comprise settings identifying at least one group of printing device controllers associated to the respective designated printing device controller for use in the spawn routing type option. The client controller may then be arranged to form the header information for the print data based on the information identifying the controllers of the at least one group of printing device controllers.

In accordance with one aspect, the configurable logic means comprises settings for compression and/or encoding of the print data and the client controller is arranged to form the header information for the print data based on the settings for compression and/or encoding of the print data stored in the configurable logic means and to compress and/or encode the print data in accordance with the settings stored in the configurable logic means.

In accordance with one aspect, the client controller arrangement further comprises a print spooling subsystem arranged to perform print spooling on the print data.

In accordance with one aspect, the client controller arrangement further comprises the client arranged to provide the print data upon a request to print to a printing device in the network.

The present disclosure also relates to a printer arrangement for a network comprising clients and printing devices. The printer arrangement comprises a printing device controller and a printing device hosting the printing device controller. The printing device controller is arranged to receive processed print data comprising header information, read the header information of the processed print data and control the processed print data in accordance with the header information. The control of the processed print data comprises
reconstructing the processed print data to a format based on the header information and providing the reconstructed print data to the printing device or another printing device controller based on the header information or
transmitting the processed print data to at least one other printing device controller based on the header information.

In accordance with one aspect, the printer arrangement is a multifunctional printing device.

In accordance with one aspect, the printer arrangement is a printer.

In accordance with one aspect, the printer arrangement is a network printer.

In accordance with one aspect, the printer arrangement further has access to configurable logic means.

In accordance with one aspect, the printing device controller is arranged to reconstruct the processed print job data to a format readable by the printing devices based on information in the configurable logic means.

In accordance with one aspect, the configurable logic means comprises a configurable logic unit arranged in the printer arrangement, said configurable logic unit being arranged to exchange information with at least one configurable logic unit of another printer arrangement and/or at least one client configurable logic unit and/or at least one network configurable unit so as to have access to updated network control information.

In accordance with one aspect, the printer arrangement further comprises a print spooling subsystem arranged to perform print spooling.

One embodiment of the present disclosure relates to a network comprising at least one client arrangement as defined above. The network may also comprise at least one printer arrangement as defined above.

One embodiment of the present disclosure relates to a network comprising at least one printer arrangement as defined above.

One embodiment of the present disclosure relates to a network comprising a plurality of clients, a plurality of printer arrangements and means for controlling the network. The means for controlling the network may be arranged to control transfer of print data in the network. The printer arrangements comprise printing device controllers each hosted by one associated printing device. The means for controlling the network comprises at least one client configurable logic unit associated with each client and/or at least one network configurable logic unit forming a node in the network and/or at least one printer configurable logic unit associated to each printing arrangement. The configurable logic units are arranged to manage network control information. The network control information may be exchanged between configurable logic units so that all configurable logic units have access to updated information. Access to relevant information throughout the system can then be provided.

In accordance with one aspect, the respective printer configurable logic unit is associated to the corresponding printing device controller.

The network control information comprises in one example information for coordination of transfer of print data. The network control information may instead or in addition thereto comprise in one option encryption keys. The network control information may instead or in addition thereto comprise automatic re-routing rules. The network control information comprises in one option defined groups of controllers for spawn functions. The network control information comprises in one option information originating from a configurable logic unit of a plurality of client configurable logic units in the network.

### BRIEF DESCRIPTION OF THE DRAWINGS

FIG. 1 illustrates schematically a first example of a client network comprising clients and printing devices.

FIG. 2 illustrates schematically a second example of a client network comprising clients and printing devices.

FIG. 3 illustrates schematically a third example of a client network comprising clients and printing devices.

FIG. 4 illustrates schematically an example of a printer arrangement.

FIG. 5 illustrates schematically an example of a client arrangement.

FIG. 6 shows a first example of the contents of processed print data sent in a network.

FIG. 7 shows a second example of the contents of processed print data sent in a network.

FIG. 8 shows a third example of the contents of processed print data sent in a network.

FIG. 9 shows a fourth example of the contents of processed print data sent in network.

FIG. 10 shows a fifth example of the contents of processed print data sent in a network.

FIG. 11 shows a sixth example of the contents of processed print data sent in a network.

FIG. 12 shows a seventh example of the contents of processed print data sent in a network.

FIG. 13 shows an eighth example of the contents of processed print data sent in a network.

FIG. 14 is a flow chart illustrating a example of a method for controlling transfer of printing jobs in a network.

### DETAILED DESCRIPTION

In the following description, for depicting and not limiting purposes, specific details are set forth, such as particular applications, techniques, methods etcetera in order to provide a thorough understanding of the present invention. It shall, however, be readily apparent to the man skilled in the art that the invention can be practised in other embodiments deviating from these specific details. In other instances detailed descriptions of well-known methods, protocols, devices or circuits are omitted in order not to obscure the present description with unnecessary details.

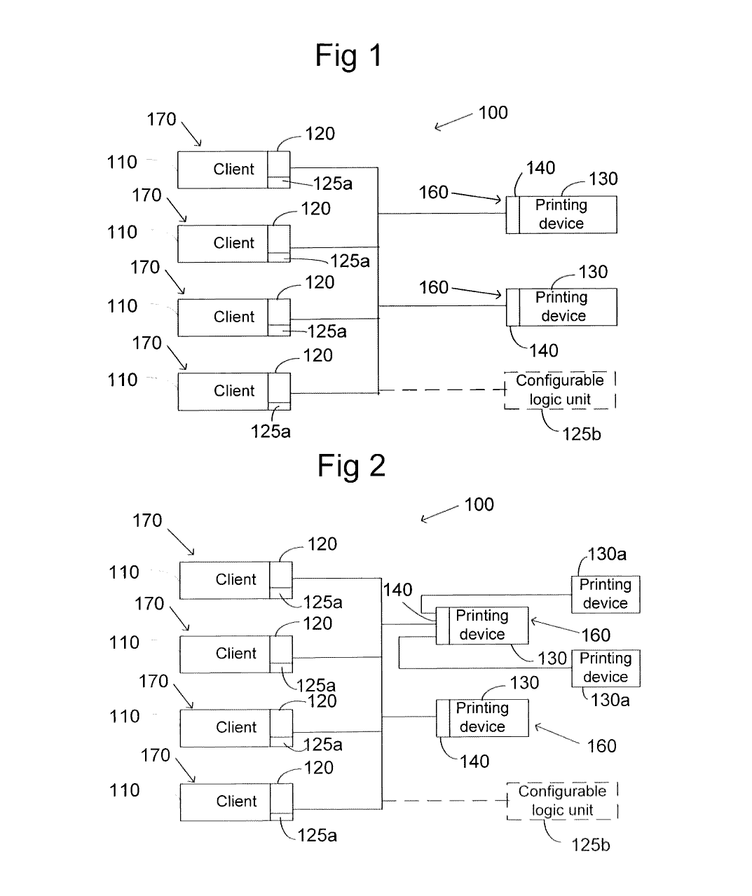

In FIGS. 1-3, a client network 100 is arranged to control transfer of print data from clients connected in the client network to shared printing devices connected in the client network 100. The client network 100 comprises a plurality of client arrangements 170. Each client arrangement 170 comprises a client or user computer 110. Each client arrangement 170 comprises further a client controller 120. In one example, the client 110 and the client controller 120 are co-located. In an alternative example, the functionality of the client controller is partly arranged at a remote location.

In one example the client controllers are also operatively connected to one or a plurality of configurable logic units 125a, 125b, 125c in the network.

The client network 100 further comprises one or a plurality of printing devices 130. Each of the printing devices 130 is associated to a corresponding printing device controller 140. The respective printing device controller is co-located with its corresponding printing device 130. The printing device controller and printing device form a printer arrangement 160. In one example, the printing device controller is integrated with its associated printing device forming the printer arrangement 160. In one example, one or a plurality of printing device controllers are in addition thereto operatively connected to one or a plurality of additional printing devices 130a. The printing device controller then serves this printing device and/or additional printing device(s) 130a.

In one example the printing devices 130 and/or printing device controllers 140 are also operatively connected to one or a plurality of configurable logic units 125a, 125b, 125c in the network.

The configurable logic unit or a distributed version thereof wherein the functionality is realized by a plurality of configurable logic units, may store at least some information related to network control. For example, it may be used to centrally store certificates, public/private keys and/or rules and/or routing tables. The configurable logic units comprise in one example at least some of the following parts: a computer, a database, and a computer program. The function of the configurable logic units will be described more in detail below.

In FIG. 4, a printer arrangement 160 comprises a printing device 130 and a printing device controller 140. In the illustrated example, the functionality of a conventional network configurable logical unit 125b is instead or in addition thereto distributed over the plurality of printer arrangements 160. In accordance with this example, the functionality of the configurable logical unit 125b of the network may be realized fully or partly in a configurable logic unit 125c arranged in or in association with the respective printing device controller 140. The printing arrangement 160 also optionally comprises a spooling subsystem 180 arranged to spool print jobs.

The printer arrangements 160 comprises in one example printing devices 130 such as printers, facsimile machines, etc. In one example, the printer arrangements 160 comprise at least one multifunctional printer comprising a printing function and/or a scanning function and/or a facsimile function. However, in the description below, the printing devices are described in relation to printers.

The printing device controller 140 comprises in one example an embedded receiving agent. The embedded receiving agent may be running on a printing core system of the printer. Alternatively, the embedded agent may be formed in a controller attached to the printer or arranged in close physical proximity to the printer. The embedded agent is in one example a software/firmware agent running on the printing device controller 140.

The printing device controller 140 is arranged to receive processed print data from the client controller, to read the received processed print data and perform actions in accordance with the received information. At least when the processed print data has not been transferred according to a spawn type routing option, the receiving printing device controller 140 is arranged to reconstruct the processed print data. The print controller 140 is then arranged to reconstruct the processed print data 400 by extracting information related to reconstruction from the processed print data and also perform decompression and/or decryption, if necessary. After reconstruction, the print data is in the originally submitted format. The reconstructed print data is then provided to an associated printer in accordance with the information in the processed print data 400.

In the spawn routing type case, the printing device controllers are configured to act as routing agents. Data can then be shared between multiple end points for the processed print data. Data resilience can thereby be enhanced. Thereby, the processed print data transmitted over the network may be shared between the printing device controllers of a defined group of printing device controllers. The identities of the group members of the print controllers are as described above in one example included in the received processed print data 400. Alternatively this information is made available to the printing device controllers via the configurable logic units. In the spawn routing type case, availability of the print data is increased. Further, performance of pull printing solutions is enabled or facilitated. In pull printing solutions, a print job may be held by a plurality of printing device controllers and a printing job may be released by a user at any printer supporting this feature and being associated to the group of controllers.

In the spawn routing type case, automatic re-routing to another printer is also enabled. Re-routing can then be performed if a requested printing device controller is not available. Re-routing can also be performed when using multicast or broadcast transmission.

In FIG. 5, a client arrangement 170 comprises a client 110 and a client controller 120 as described above. The client arrangement 170 comprises also in one example a configurable logic unit 125a. The client arrangement 170 also optionally comprises a spooling subsystem 190 arranged to spool print data.

In detail, the client arrangement may comprise a main program and a number of sub-programs, which together form the client depending on the operative system of the client. The main program may be adapted to handle several print jobs simultaneously, and to process correct information for correct printing. Further, the programs have functionality in order to show dialogue windows with information.

The clients 110 comprise for example personal computers, laptops, etc. The clients 110 may in addition thereto or instead comprise host backend systems (such as SAP, Mainframes ERM etc). The clients 110 may instead or in addition thereto comprise one or a plurality of smart phones and/or tablets.

In operation, in order to control transfer of print data from clients 110 connected in the network to printing devices 130, 130a connected in the network, the client may receive a request to transfer a printing job to a printing device 130, 130a connected in the network. A request may be made via a user interface. The request may comprise a selection of the printing device 130, 130a to which the transfer is requested. The client 110 is arranged to provide the print data to the client controller 120 in response to this request.

As stated above, the clients 110 submit print data for example upon a user request to perform a print job. The print data may be submitted as a raw data stream. It may then be spooled. The spooling may take place either at the client arrangement 170 or the printer arrangement 160, or both. The print data is submitted to the client controller 120. In the example of the FIGS. 1-3, each client 110 is associated to one client controller 120. In one example, the clients 110 provide print data to the client controllers 120 via standard data transmission via a standard data transmission protocols. In one example the client controller 120 accepts data streams via TCP/IP or WSAPI or similar protocols.

The client controller 120 is arranged to form header information for the print data based on information in the client configurable logic unit 125a, and/or the network configurable logic unit 125b and/or the printer configurable logic unit 125c. The client configurable logic unit 125a and/or the network configurable logic unit 125b and/or the printer configurable logic unit 125c comprise settings for network control. The settings may be set by an administrator of the network. The configurable logic unit 125a/125b/125c may comprise information related to the designated printing device controllers of the network and one or a plurality of printing devices associated to the respective printing device. The configurable logic unit 125a/125b/125c may comprise information about a plurality of routing type options. The settings for network control then comprise settings for the plurality of routing type options. The routing type option comprises for example a direct transfer option and/or an option for indirect transfer via the designated printing device controller, and/or spawn. The configurable logic unit 125a/125b/125c may also comprise information about one or a plurality of compression options. The settings for network control comprise then settings for the one or a plurality of compression options. The configurable logic unit 125a/125b/125c may also comprise information about one or a plurality of encoding options. The settings for network control comprise then settings for the one or a plurality of encoding options. The configurable logic unit 125a/125b/125c may also comprise information about one or a plurality of security options. The settings for network control comprise then settings for the one or a plurality of security options. The configurable logic unit 125a/125b/125c may also comprise information about one or a plurality of additional options. The settings for network control comprise then settings for the one or a plurality of additional options. The additional options comprise for example different types of printing settings.

The header information comprises information related to a designated printing device controller identified based on the printing device. Thus, a designated printing device controller 140 is identified based on the identity of the printing device 130, 130a, and comprised in the header information. The header information may also comprise other type of information for use by the designated printing device controller and possibly by one or a plurality of other printing device controllers to which the print data with the header information will be provided from the designated printing device controller. This information will partly or in full be provided from the configurable logic unit 125a/125b/125c. This information will be described more in detail later. The client controller 120 is further arranged to process the print data to provide processed print data comprising the header information. The client controller 120 is then arranged to transfer the processed print data to the designated printing device controller 140. Reconstructed print data is then formed at the designated printing device controller or at another printing device controller to which the processed print data has been provided from the designated printing device controller. The reconstructed print data is then transferred to the printing device.

The client controller 120 may further be arranged to process the received print data so as to perform compression and/or encryption and/or routing based on the header information. The client controller 120 is then arranged to transmit the processed print data from the client using a method allowing compression and/or encryption and/or routing. The processed print data transmitted by the client controller 120 may be submitted as a processed data stream.

The control unit 120 is arranged to route the print data to the printer. A printer selection may be made when making the request to perform a print job.

In one example, more than one routing option is available for routing the print data to the selected printer.

FIG. 1 illustrates a case wherein the direct transfer option is set. The control unit 120 is then arranged to send the processed print data to the selected printer using a direct transfer data transmission protocol. In accordance with this example, the processed print data transmitted from the client controller comprises destination information. The destination information comprises information identifying the designated printing device controller 140 or the printing device 130. In this case illustrated in FIG. 1, the printing controller 140 is co-located with the printing device 130.

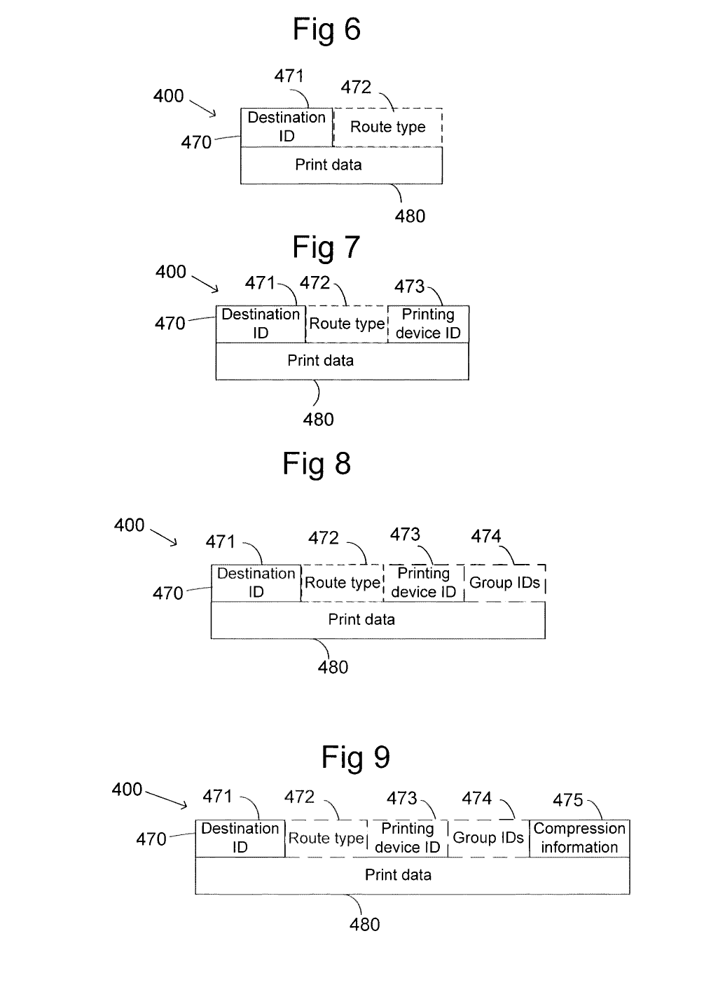

FIG. 6 illustrates an example of the data format of a processed print data 400 transmitted from the client controller 120 in accordance with a direct transfer option. In the example of FIG. 6, the processed print data 400 transmitted from the client controller 120 comprises print data 480 header information 470. The header information comprises field for a designated printing device controller ID 471 or other information identifying the designated printing device controller associated to the selected printing device. Optionally, the header information comprises a field for route type data 472 indicating the routing type option which is to be used. The printing device controller ID could also be substituted with the printing device ID. The settings for network control of the configurable logic unit 125a and/or 125b and/or 125c may comprise settings for associating for each printing device controller ID in the direct transfer option, the printing device controller ID to one associated printer ID.

FIG. 2 illustrates a case wherein an option for indirect transfer via the designated printing device controller may be set. In the example of this figure, one of the printing device controllers is serving the printing device to which it is co-located and at least one additional printer 130a. The additional printer 130a may be a simple printing device without an associated printing device controller. The client controller 120 may be arranged to route the processed print data to the printing device via the destination printing device controller to the printing device. In accordance with this example, the processed print data transmitted from the client controller 120 comprises the designated printing device controller ID and the information identifying the printing device. The settings for network control of the configurable logic unit 125a and/or 125b and/or 125c may comprise settings for associating each printing device controller ID in the option for indirect transfer, to one or a plurality of associated printer IDs.

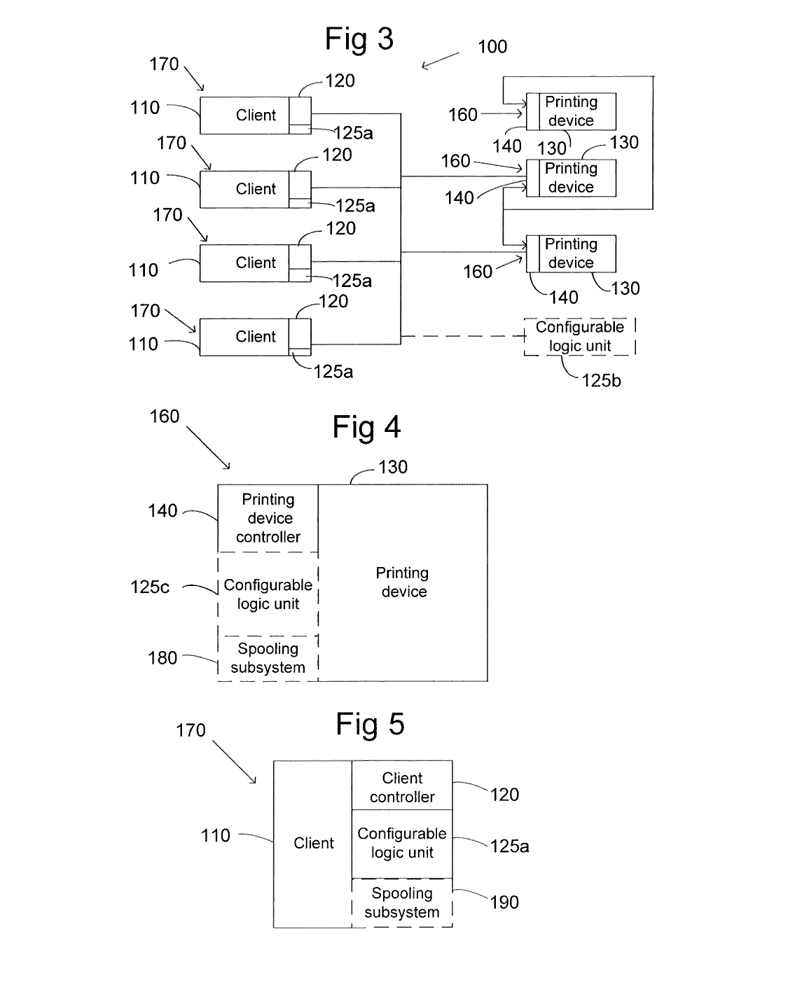

FIG. 3 illustrates an alternative case wherein option for indirect transfer via the designated printing device controller to a destination printing device controller may be set. The client controller 120 may then be arranged to route the processed print data to the destination printing device controller via the designation printing device controller. In accordance with this example, the processed print data transmitted from the client controller 120 comprises the designated printing device controller ID and possibly information identifying the destination printing device controller ID. It may also comprise information identifying the printing device. The settings for network control of the configurable logic unit 125a and/or 125b and/or 125c may comprise settings for associating, for each printing device controller, a printing device controller ID, representing the designated printing device controller via which the processed print data is transferred to the destination printing device controller.

FIG. 7 illustrates an example of the data format of the processed print data 400 transmitted from the client controller 120 in the option for indirect transfer via the designated printing device controller to the destination printing device controller. In the example of FIG. 7, the processed print data 400 transmitted from the client controller 120 comprises print data 480, and header information 470. In accordance with this example, the header information 470 of this processed print data transmitted from the client controller 120 comprises the designated printing device controller ID 471 and the information 473 identifying the printing device or the destination printing device controller. Optionally, the header information comprises a field for route type data 472 indicating the routing option which is used.

FIG. 3 also illustrates a case wherein the spawn option may be set. The client controller 120 is then arranged to route the print data to the printing device or another printer by means of spawn via one or more printing device controllers. When the spawn option is set, the information transmitted from the client controller may comprise ID information related to members of a group of printing device controllers for spawning from the designated printing device controller. The settings for network control of the configurable logic unit 125a and/or 125b and/or 125c may comprise settings for associating, for each printing device controller ID, information related to members of a group of printing device controllers for spawning from the designated printing device controller in the spawn option.

FIG. 8 illustrates an example of the data format of a processed print data 400 transmitted from the client controller 120 in the spawning option. In the example of FIG. 8, the processed print data 400 transmitted from the client controller 120 comprises print data 480 and header information 470. The header information 470 comprises designated printing device controller ID 471. It may also comprise the information identifying the printing device 473. Optionally, the header information 470 comprises a field for route type data 472 indicating the routing option which is used. Further, the header information 470 may comprise information 474 related to members of a group of printing device controllers for spawning from the designated printing device controller. The printing jobs can then for example be transmitted between the printing device controllers of the group of printing device controllers using peer-to-peer technologies.

In one example the client controller 120 is arranged to compress the at least the print data before transfer from the client. FIG. 9 illustrates one example of the processed print data 400 when the client controller 120 has performed compressing of the print data. In this case the print data 480 of the processed print data 400 is compressed. The header information 470 of the processed print data 400 comprises further compression information 475. In one example the compression information is a flag indicating that the print data is compressed. In addition thereto, the compression information may comprise information for use in decompression. Alternatively this information is already known to the printing device controllers. The configurable logic unit 125a and/or 125b and/or 125c may comprise settings for the compression information 475.

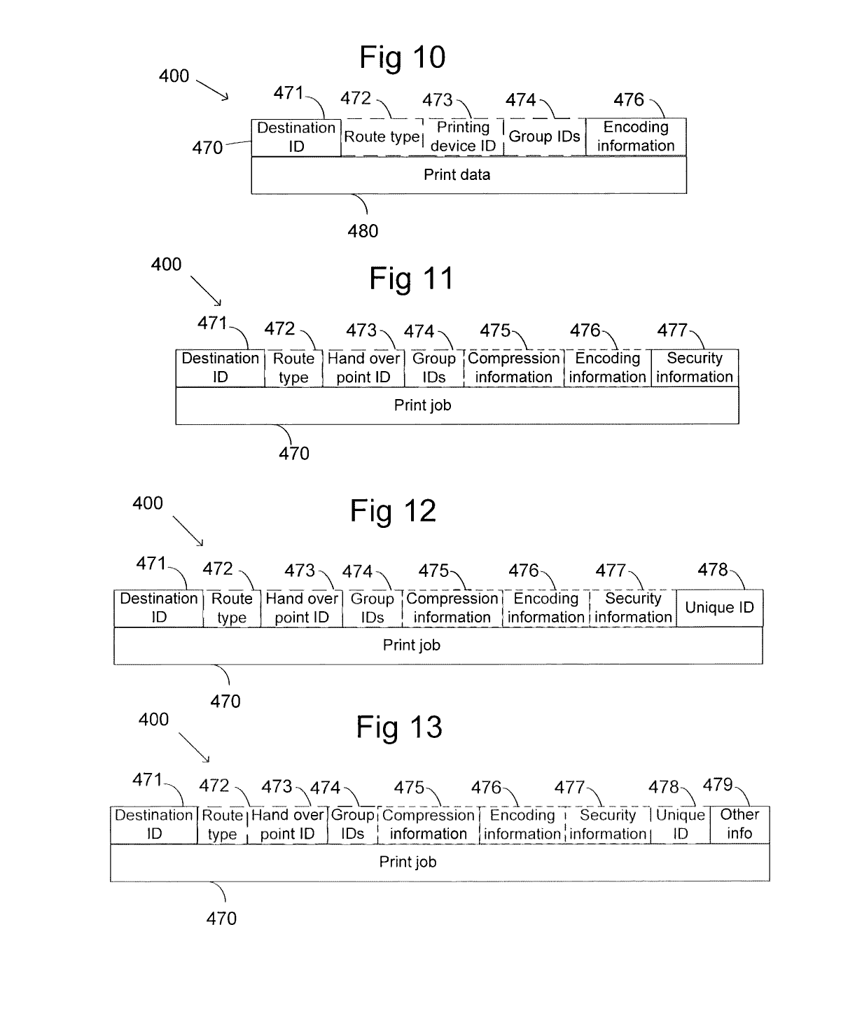

In one example the client controller 120 is arranged to encode at least the print data 480 of the processed print data 400 before transfer from the client controller. FIG. 10 illustrates one example of the processed print data 400 wherein the client controller 120 has performed encoding of the print data. In this case the print data 480 of the processed print data 400 is encoded. The header information 470 of the processed print data 400 comprises further encoding information 476. In one example, the encoding information 476 is a flag indicating that the print data is encoded. In addition thereto, the encoding information may comprise one or a plurality of keys for use in decoding. Alternatively this information is already known to the printing device controllers. The configurable logic unit 125a and/or 125b and/or 125c may comprise settings for the encoding information.

In one example the client controller 120 is arranged to provide security information related to the print data before transfer from the client. FIG. 11 illustrates one example of the processed print data, wherein the header information 470 comprises security information 477 associated to the print data. The security information may comprise a security classification. One security classification level may be “off”. One security classification level may be that only that printing device which is associated to the designated printing device controller can print the print data. One security classification level may be “no spawn”.

In the example of FIG. 12, the print data is assigned an identity. Information related to a unique identity 478 can then form part of the header information 470 of the print data 400. By the inclusion of the unique identity of the print data, tracking of the print data is enabled. The unique identity may be a counter value.

In the example of FIG. 13, additional information 479 may form part of the header information 470 of the print data 400. By the inclusion of the additional information other type of data relevant for printing may be included. For example, the additional information may comprise information related to relations between different packages of print data if a printing job has been divided into a plurality of print data packages.

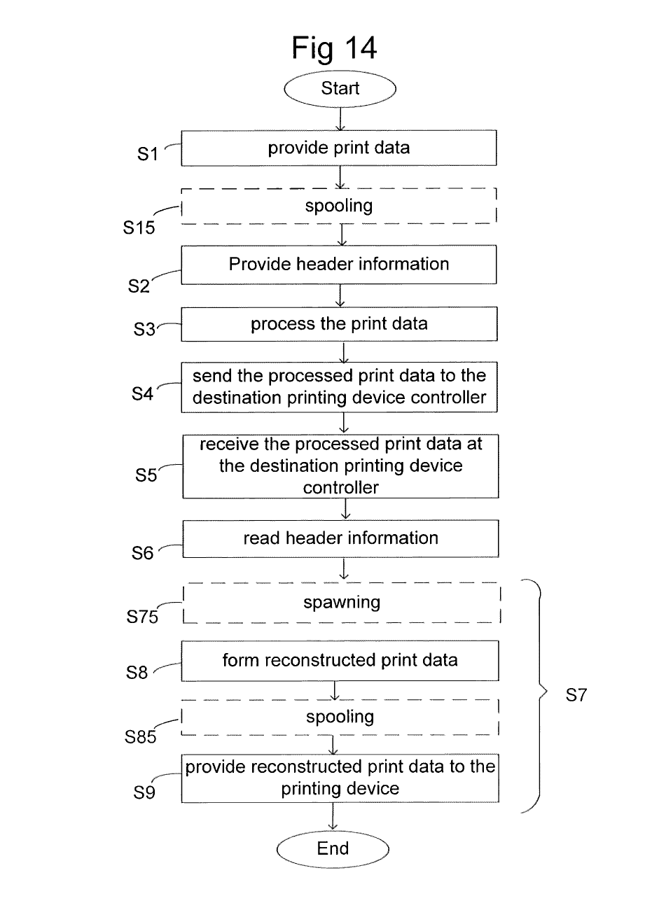

In FIG. 14, a method for controlling transfer of print data from clients connected in a network to shared printing devices connected in the network comprises the following steps. Print data is provided S1 upon reception of a request to send to a printing device connected in the network. The request may be a user request. The request may comprise a selection of a printing device.

Thereafter, header information is formed S2 for the print data based on information provided by a configurable logic means. The header information comprises information related to at least one designated printing device controller which may be identified based on the request to send to a printing device.

The print data is then processed S3 so as to provide processed print data comprising the formed header information.

The processed print data is then sent S4 to the at least one designated printing device controller.

The processed print data is received S5 at the designated printing device controller.

The designated printing device controller reads S6 the header information of the received processed print data and controls S7 the processed print data in accordance with the header information.

The controlling comprises forming reconstructed print data S8 from the processed print data received at a destination printing device controller based on the header information, and providing S9 the reconstructed print data to the printing device.

In one example, the step of forming S2 the header information further comprises adding routing type information to the header information, wherein the routing type information is provided from the configurable logic means comprising settings for a plurality of routing type options. The step of controlling the processed print data can then be performed in accordance with the routing type information. The methods which may be used in the respective routing types, as described below, are based on a configuration, wherein the printing device controllers are located in or associated to a printing device and wherein there may be printers which are regarded as external but operatively and/or logically connected to a corresponding printing device controller. The connection may for example be made by wiring or via a radio network.

The plurality of routing type options comprises in one example a direct transfer option, in which option printing is performed at that printing device to which the designated printing device controller is associated. In this option, the destination printing device controller is the designated printing device controller. If the direct transfer option is set in the configurable logic means, the step of forming S7 the reconstructed print data is in one example performed at the designated printing device controller, and the step of providing S9 the reconstructed print data to the printing device comprises providing the reconstructed print data to that printing device to which the designated printing device controller is associated.

The plurality of routing type options comprises in one example indirect transfer via the designated printing device controller. The indirect transfer is in one example performed via the designated printing device controller to the destination printing device controller. In another combinable example, the indirect transfer is performed via the designated printing device controller to the destination printing device controller. The indirect transfer can then be performed from the designated printing device or destination printing device to the printing device for printing.

When the indirect transfer option is set and a transfer is made to the printing device, the step of forming S8 the reconstructed print data is performed at the designated or destination printing device controller. The step of providing S9 the reconstructed print data to the printing device comprises transferring the reconstructed print data to the printing device, wherein the printing device is controlled by the designated or destination printing device controller. The step of providing S9 the reconstructed print data to the printing device comprises providing the reconstructed print data to the printing device to which the printing device controller is associated or to an external printing device operatively connected to the printing device controller.

In the example with indirect transfer via the designated printing device controller, the step of processing S3 the print data further comprises adding information related to the additional/external printing device and/or the destination printing device controller to the print data. The transfer to the additional printing device and/or the destination printing device controller is performed based on this information, as stated above. The additional/external printing device and/or other printing device controller may be selected at the client. It may be selected by a user at the client.

The plurality of routing type options comprises in one example spawn. If the spawn option is set in the configurable logic means, a spawning step S75 comprises transmitting the processed print data to a group of printing device controllers comprising the designated printing device controller. In one example, the step of providing S9 the reconstructed print data to the printing device comprises providing the reconstructed print data to the printing device based on a printing device user selection made after sending from the client.

In one example, the step of forming S8 the reconstructed print data from the processed print data received at the designated printing device controller is made at the designated printing device controller. Alternatively, the forming S8 of the reconstructed print data is performed at the printing device controller operatively connected/associated to the user selected printing device.

In one example, the step of processing S3 the print data further comprises adding information identifying the controllers of the group of printing device controllers. The information identifying the controllers of the group of printing device controllers may be stored in the configurable logic means. In one example, the print data is transmitted to the controllers of the group of printing device controllers using peer-to-peer technology. In one example, the print data is transmitted to the controllers for use in conjunction with pull printing.

In one example, the forming S2 of the header information comprises including information identifying a plurality of printing device controllers and wherein the sending of the processed print data to the designated printing device controller is performed using multicast or broadcast transmission. In one example, all available printing device controllers are identified. The respective printing device controller may be arranged to determine whether to accept reception of the sent processed print data.

In one example, the step of processing S3 the print data further comprises compressing and/or encoding the print data and the step of forming S8 the reconstructed print data comprises performing decompression and/or decoding.

In one example, the method comprises a step of performing print spooling S15, S85 of the print data. The print spooling may be performed S15 before sending from the client to the printing device and/or the print spooling may be performed S85 after reception at the designated printing device controller. The print spooling may be performed before or after processing of the print data. The print spooling made after reception by the designated printing device controller may be performed before or after forming the reconstructed print data. In one example, print spooling is performed in conjunction with pull printing.

In one example, configurable logic units in the network may exchange network control information so that all the configurable logic units are updated with relevant information.

1. A method for controlling transfer of print data from clients connected in a network to shared printing devices connected in the network, the method comprises the steps of:
providing print data upon reception of a request to print to a printing device connected in the network,
forming header information for the print data based on information provided by a configurable logic means, wherein said header information comprises information related to at least one designated printing device controller identified based on the request to print to a printing device,
processing the print data so as to provide processed print data comprising the formed header information,
sending the processed print data to the at least one designated printing device controller,
receiving the processed print data at the designated printing device controller,
reading at the designated printing device controller the header information of the received processed print data and
controlling the processed print data in accordance with the header information, said controlling comprises
forming reconstructed print data from the processed print data at a destination printing device controller based on the header information, and
providing the reconstructed print data to the printing device.

2. A method for controlling transfer of print data according to claim 1, wherein
the step of forming the header information further comprises adding routing type information to the header information, wherein the routing type information is provided from the configurable logic means comprising settings for a plurality of routing type options.

3. A method for controlling transfer of print data according to claim 2, wherein the plurality of routing type options comprises a direct transfer option, in which option the destination printing device controller is the designated printing device controller and in which option printing is performed at that printing device to which the designated printing device controller is associated.

4. A method for controlling transfer of print data according to claim 3, wherein the direct transfer option is set in the configurable logic means,
the step of forming the reconstructed print data is performed at the designated printing device controller, and
the step of providing the reconstructed print data to the printing device comprises providing the reconstructed print data to that printing device to which the designated printing device controller is associated.

5. A method for controlling transfer of print data according to claim 2, wherein the plurality of routing type options comprises indirect transfer via the designated printing device controller.

6. A method according to claim 5, wherein the indirect transfer is performed via the designated printing device controller to the destination printing device controller.

7. A method according to claim 5, wherein the indirect transfer is performed from the designated printing device or destination printing device to a printing device for printing.

8. A method for controlling transfer of print data according to claim 5, wherein the indirect transfer is set in the configurable logic means,
the step of forming the reconstructed print data is performed at the designated or destination printing device controller, and
the step of providing the reconstructed print data to the printing device comprises transferring the reconstructed print data to the printing device, wherein the printing device is controlled by the designated or destination printing device controller.

9. A method for controlling transfer of print data according to claim 7, wherein the step of processing the print data further comprises adding information related to the printing device to the print data and wherein the transfer to the printing device is performed based on this information.

10. A method for controlling transfer of print data according to claim 6, wherein the step of processing the print data further comprises adding information related to the destination printing device controller to the print data and wherein the transfer is performed based on this information.

11. A method for controlling transfer of print data according to claim 2, wherein the plurality of routing type options comprises spawn.

12. A method for controlling transfer of print data according to claim 11, wherein the spawn option is set in the configurable logic means, and wherein
a spawning step comprises transmitting the processed print data to a group of printing device controllers comprising the designated printing device controller, and
the step of providing the reconstructed print data to the printing device comprises providing the reconstructed print data to the printing device based on a printing device user selection made after sending from the client.

13. A method for controlling transfer of print data according to claim 12, wherein the step of processing the print data further comprises adding information identifying the printing device controllers of the group of printing device controllers.

14. A method for controlling transfer of print data according to claim 12, wherein the print data is transmitted to the controllers of the group of printing device controllers using peer-to-peer technology.

15. A method for controlling transfer of print data according to claim 2, wherein the print data is transmitted to the controllers of the group of printing device controllers for use in conjunction with pull printing.

16. A method according to claim 1, wherein the forming of the header information comprises including information identifying a plurality of printing device controllers and wherein the sending of the processed print data to the designated printing device controller is performed using multicast or broadcast transmission.

17. A method for controlling transfer of print data according to claim 1, wherein
the step of processing the print data further comprises compressing and/or encoding the print data and
the step of forming the reconstructed print data comprises performing decompression and/or decoding.

18. A method according to claim 1, further comprising a step of performing print spooling on the print data.

19. A method according to claim 18, wherein the step of performing print spooling is performed before sending from the client to the printing device.

20. A method according to claim 18, wherein the step of performing print spooling is performed at the designated or destination printing device controller.

21. A method according to claim 18, wherein a step of performing print spooling is performed in conjunction with pull printing.

22. A method according to claim 1, wherein the configurable logic units in the network transfer updated network controller information between them so that all the configurable logic units are updated with relevant network controller information.

23. Software for executing the steps of the method according to claim 1.

24. A client controller arrangement for controlling transfer of print data from a client connected in a network to one of a plurality of printing devices connected in the network, the client controller arrangement comprising a client controller and having access to configurable logic means,
wherein the client controller is arranged to
receive print data from the client upon a request to print to a printing device in the network,
form header information for the print data based on information in the configurable logic means, wherein the header information comprises information related to at least one designated printing device controller identified based on the printing device and
processing the print data so as to provide processed print data comprising the formed header information and
sending the processed print data to the at least one designated printing device controller.

25. A client controller arrangement according to claim 24, wherein the configurable logic means are arranged to store settings identifying one printing device controller associated to each of a plurality of the printing devices of the network.

26. A client controller arrangement according to claim 24, wherein the configurable logic means comprise settings for a plurality of routing type options, wherein the client controller is arranged to process the print data so as to add routing type information to the print data based on the settings of the configurable logic means.

27. A client controller arrangement according to claim 26, wherein the configurable logic means comprise settings for at least two of the following routing type options:
a direct transfer option, wherein printing is performed at that printing device to which the designated printing device controller is associated,
an option for indirect transfer via the designated printing device controller, and
spawn.

28. A client controller arrangement according to claim 27, wherein the option for indirect transfer comprises the following two combinable options:
an option for indirect transfer to a destination printing device controller, and
an option for indirect transfer to the printing device.

29. A client controller arrangement according to claim 27, wherein the configurable logic means comprises settings identifying at least one group of printing device controllers associated to the respective designated printing device controller for use in the spawn routing type option.

30. A client controller arrangement according to claim 27, wherein the client controller is arranged to form the header information for the print data based on the information identifying the controllers of the at least one group of printing device controllers.

31. A client controller arrangement according to claim 24, wherein the configurable logic means comprise settings for compression and/or encoding of the print data and the client controller is arranged to form the header information for the print data based on the settings for compression and/or encoding of the print data stored in the configurable logic means and to compress and/or encode the print data in accordance with the settings stored in the configurable logic means.

32. A client controller arrangement according to claim 24, further comprising a print spooling subsystem arranged to perform print spooling on the print data.

33. A client controller arrangement according to claim 24, further comprising the client arranged to provide the print data upon a request to print to a printing device in the network.

34. A printer arrangement for a network comprising clients and printing devices said printer arrangement comprising a printing device controller and a printing device hosting the printing device controller, wherein the printing device controller is arranged to receive processed print data comprising header information, read the header information of the processed print data and control the processed print data in accordance with the header information, wherein the control of the processed print data comprises
reconstructing the processed print data to a format readable by the printing devices based on the header information and providing the reconstructed print data to the printing device or another printing device controller based on the header information or
transmitting the processed print data to at least one other printing device controller based on the header information.

35. A printer arrangement according to claim 34, wherein the printer arrangement is a multifunctional printing device.

36. A printer arrangement according to claim 34, wherein the printer arrangement is a printer.

37. A printer arrangement according to claim 34, wherein the printer arrangement is a network printer.

38. A printer arrangement according to claim 34, further having access to configurable logic means.

39. A printer arrangement according to claim 38, wherein the printing device controller is arranged to reconstruct the processed print data to a format readable by the printing devices based on information in the configurable logic means.

40. A printer arrangement according to claim 38, wherein the configurable logic means comprises a configurable logic unit arranged in the printer arrangement, said configurable logic unit being arranged to exchange information with at least one configurable logic unit of another printer arrangement and/or at least one client configurable logic unit and/or at least one network configurable unit so as to have access to updated network control information.

41. A printer arrangement according to claim 34, further comprising a print spooling subsystem arranged to perform print spooling.

42. A network comprising at least one client arrangement according to claim 24.

43. A network according to claim 40, further comprising at least one printer arrangement controller according to claim 34.

44. A network comprising at least one printer arrangement according to claim 34.

45. A network comprising a plurality of clients, a plurality of printing arrangements and means for controlling the network, characterized in that the printing arrangements comprise printing device controllers each hosted by one associated printing device and that the means for controlling the network comprises at least one client configurable logic unit associated to each client and/or at least one network configurable logic unit forming a node in the network and/or at least one printer configurable logic unit associated to each printing arrangement, wherein the configurable logic units are arranged to provide network control information and wherein information is exchanged between the configurable logic units so that all configurable logic units have access to updated information.

46. A network according to claim 45, wherein the respective printer configurable logic unit is associated to the corresponding printing device controller.

47. A network according to claim 45, wherein the network control information comprises information for coordination of transfer of print data.

48. A network according to claim 45, wherein the network control information comprises automatic re-routing rules.

49. A network according to claim 45, wherein the network control information comprises encryption keys.

50. A network according to claim 45, wherein the network information comprises information originating from a configurable logic unit of a plurality of client configurable logic units in the network.

51. A network according to claim 45, wherein the network control information comprises defined groups of controllers for spawn functions.
